(19) United States
(12) Patent Application Publication
(10) Pub. No.: US 2023/0124772 A1
(43) Pub. Date: Apr. 20, 2023

(54) ADJUSTABLE LEVER FOR A CENTRIFUGAL ACTUATOR OF A CONTINUOUSLY VARIABLE TRANSMISSION DRIVE PULLEY

(71) Applicant: 1431209 Alberta Inc., Yellowhead County (CA)

(72) Inventor: Jeffery Wade Lasko, Edson (CA)

(21) Appl. No.: 17/454,024

(22) Filed: Nov. 8, 2021

(30) Foreign Application Priority Data
Oct. 14, 2021 (CA) 3,134,283

(51) Int. Cl. F16H 9/12; F16H 9/18; F16H 55/56; F16H 61/662

(52) U.S. Cl. CPC F16H 9/125; F16H 9/18; F16H 55/563; F16H 61/66254

(57) ABSTRACT

The present disclosure pertains to an adjustable lever for a centrifugal actuator of a continuously variable transmission drive pulley, the adjustable lever including a first extension and a second extension each for receiving a removable weight. The present disclosure also provides kits comprising an adjustable lever as disclosed herein and at least one first removable weight, at least one second removable weight, or both.

### CROSS-REFERENCE TO RELATED APPLICATION

This application claims priority to and benefit of Canadian Patent Application Serial No. 3,134,283 filed on Oct. 14, 2021, which is hereby incorporated by reference.

### TECHNICAL FIELD

The present disclosure generally relates to adjustable levers of continuously variable transmission drive pulleys, and in particular to an adjustable lever for a centrifugal actuator of a pDrive clutch. In certain embodiments, the adjustable lever may be used in snowmobile drivetrains.

### BACKGROUND

Many recreational vehicles, such as snowmobiles, have a continuous variable transmission (CVT). Recent advances in CVT technology include redesigned drive pulleys (e.g. pDrive clutches) that include centrifugal actuators, such as described in U.S. Pat. No. 9,267,580.

Although these new drivetrain systems have resulted in improved operator experience, there have been issues with proper calibration and adjustability in the clutching, particularly for certain applications and functionalities (e.g. a high rpm tune, riding at different elevations, etc.). This has resulted in both performance and response limitations, particularly when shifting gears. For example, a snowmobile operator may have to apply inconsistent force to the throttle lever to change the rotation speed of the drive pulley. Since changes in terrain require the ability to quickly shift gears in a reliable manner and snowmobile operators may become adapted to having the throttle lever in a consistent position when changing gears, having to apply more or less force may be disruptive to the operator's experience.

Tuning of a CVT clutch can involve many factors. For example, there are manufactures that provide replacement arms (flyweights) for centrifugal actuators with a different profile than the original equipment manufacturer (OEM) arms. However, many of these alter desired performance characteristics of the OEM flyweight setup and have no adjustability. While replacement arms designed to adjust the centre of gravity and increase the weight in the tail portion of the arm are available, the OEM arm must again be replaced and the desired performance may still not be achieved.

A need therefore exists for improved components of a centrifugal actuator that provide enhanced performance, response and calibration, for example when shifting gears or to achieve particular functionalities (e.g. a high rpm tune).

### SUMMARY

The present disclosure relates to an adjustable lever for a centrifugal actuator of a continuously variable transmission (CVT) drive pulley. The present disclosure recognizes that there are problems and/or limitations with current centrifugal actuators in respect of operational performance, for example, in snowmobiles.

At least one advantage of the present disclosure is the provision of adjustable levers, and in particular Lh levers in centrifugal actuators of pDrive clutches, having improved characteristics over existing technologies.

In an embodiment, the present disclosure relates to an adjustable lever for a centrifugal actuator of a continuously variable transmission drive pulley, the adjustable lever comprising: a first aperture operatively engageable with a head portion of an arm of the centrifugal actuator; a second aperture operatively engageable with a pivot point of the arm; a third aperture for receiving a first removable weight therewithin, the third aperture located in a first extension of the adjustable lever and positioned beyond the outer curvature of the head portion of the arm when the adjustable lever is operatively engaged with the arm; and a fourth aperture for receiving a second removable weight therewithin, the fourth aperture located in a second extension of the adjustable lever and positioned adjacent the space underneath a tail portion of the arm when the adjustable lever is operatively engaged with the arm.

In an embodiment, the present disclosure relates to an adjustable lever for a centrifugal actuator of a continuously variable transmission drive pulley, the adjustable lever comprising: a first aperture operatively engageable with a head portion of an arm of the centrifugal actuator; a second aperture operatively engageable with a pivot point of the arm; a first receiver for receiving a first removable weight therewithin, the first receiver located on a first extension of the adjustable lever and positioned beyond the outer curvature of the head portion of the arm when the adjustable lever is operatively engaged with the arm; and a second receiver for receiving a second removable weight therewithin, the second receiver located on a second extension of the adjustable lever and positioned adjacent the space underneath a tail portion of the arm when the adjustable lever is operatively engaged with the arm.

In an embodiment, the present disclosure relates to a kit comprising: an adjustable lever for a centrifugal actuator of a continuously variable transmission drive pulley, the adjustable lever comprising: a first aperture operatively engageable with a head portion of an arm of the centrifugal actuator; a second aperture operatively engageable with a pivot point of the arm; a third aperture for receiving a first removable weight therewithin, the third aperture located in a first extension of the adjustable lever and positioned beyond the outer curvature of the head portion of the arm when the adjustable lever is operatively engaged with the arm; and a fourth aperture for receiving a second removable weight therewithin, the fourth aperture located in a second extension of the adjustable lever and positioned adjacent the space underneath a tail portion of the arm when the adjustable lever is operatively engaged with the arm; and at least one of the first removable weight, the second removable weight, or both.

In an embodiment, the present disclosure relates to a kit comprising: an adjustable lever for a centrifugal actuator of a continuously variable transmission drive pulley, the adjustable lever comprising: a first aperture operatively engageable with a head portion of an arm of the centrifugal actuator; a second aperture operatively engageable with a pivot point of the arm; a first receiver for receiving a first removable weight therewithin, the first receiver located on a first extension of the adjustable lever and positioned beyond the outer curvature of the head portion of the arm when the adjustable lever is operatively engaged with the arm; and a second receiver for receiving a second removable weight therewithin, the second receiver located on a second extension of the adjustable lever and positioned adjacent the space underneath a tail portion of the arm when the adjustable lever is operatively engaged with the arm; and at least one of the first removable weight, the second removable weight, or both.

Other aspects and embodiments of the present disclosure will be evident in view of the detailed description provided herein.

### BRIEF DESCRIPTION OF THE DRAWINGS

Further advantages, permutations and combinations of the invention will now appear from the above and from the following detailed description of the various particular embodiments of the invention taken together with the accompanying drawings. The appended drawings illustrate one or more embodiments of the present disclosure by way of example only and are not to be construed as limiting the scope of the present disclosure.

FIG. 1 is a prior art representation of a centrifugal actuator of a continuously variable transmission drive pulley, taken from U.S. Pat. No. 9,267,580.

FIG. 2 is a perspective view of an exemplary prior art arm of a centrifugal actuator, which is capable of operatively engaging the adjustable lever disclosed herein.

FIG. 3 is a perspective view of an exemplary embodiment of an adjustable lever according to the present disclosure.

FIG. 4 is a side view of a further exemplary embodiment of an adjustable lever according to the present disclosure.

FIG. 5 is a side view of yet a further exemplary embodiment of an adjustable lever according to the present disclosure.

FIG. 6 is a perspective view of the adjustable lever shown in FIG. 3 operatively engaged to an arm of a centrifugal actuator and having positioned therein embodiments of the first and second adjustable weights.

FIG. 7 is a first side view of the adjustable lever shown in FIG. 3 operatively engaged to an arm of a centrifugal actuator and having positioned therein embodiments of the first and second adjustable weights.

FIG. 8 is a first side view of the adjustable lever shown in FIG. 4 operatively engaged to an arm of a centrifugal actuator and having positioned therein embodiments of the first and second adjustable weights.

FIG. 9 is a second side view of the adjustable lever and arm assembly of FIG. 7, showing the lock on the opposite side of the arm relative to the adjustable lever.

FIG. 10 is a perspective view of another exemplary embodiment of an adjustable lever according to some embodiments of the present disclosure.

FIG. 11 is a perspective view of yet another exemplary embodiment of an adjustable lever according to some embodiments of the present disclosure.

FIG. 12 is an exemplary kit according to some embodiments of the present disclosure, comprising the adjustable levers of FIG. 4.

### DETAILED DESCRIPTION

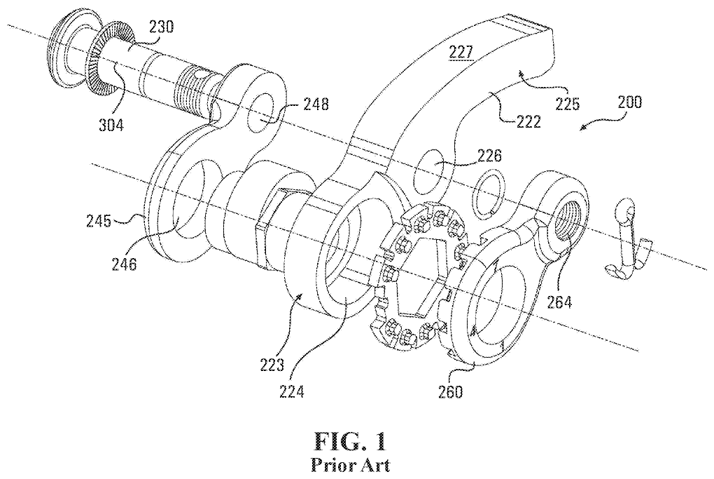

Many types of vehicles, including recreational vehicles, may use continuous variable transmission (CVT) drive pulleys having centrifugal actuators. An exemplary centrifugal actuator of a CVT drive pulley is disclosed in U.S. Pat. No. 9,267,580 and shown in FIG. 1.

In FIG. 1, the centrifugal actuator 200 comprises an arm 222 having a head portion 223 with a first aperture 224 and a tail portion 225. The tail portion 225 includes a second aperture 226 and has a curved arm portion that defines a cam surface 227. The arm 222 is positionable with respect to a movable sheave of a drive pulley by pivoting about the axis 304 through the aperture 226, referred to herein as a pivot point.

The centrifugal actuator 200 also includes a lever 245 having two apertures 246 and 248. The lever 245 is operatively engageable to the arm 222 by for example inserting a fastener 230 through both the aperture 248 of the lever 245 and the aperture 226 of the arm 222 and securing through an aperture 264 of a lock 260.

The present disclosure relates to an adjustable lever for a centrifugal actuator of a CVT drive pulley, and more particularly a centrifugal actuator of a pDrive clutch, such as for example the centrifugal actuator 200 shown in FIG. 1. The disclosure herein largely discusses the technology in the context of a CVT for a snowmobile but it will be appreciated that other applications are equally suitable, such as for example for a side-by-side vehicle (e.g. ATV, UTV, etc.). The skilled person will appreciate that removable weights having a mass outside of the ranges disclosed herein (for example, heavier removable weights) may be required to achieve the target weight and adjustability for such applications.

The adjustable levers of the present disclosure, and kits comprising the levers, are advantageous in a number of aspects. One advantage of the present disclosure is the provision of levers that permit weight adjustability at the arm of the centrifugal actuator without having to replace the original equipment manufacture (OEM) arm. Another advantage of the present disclosure is the multi-point adjustability of the adjustable levers disclosed herein. Taking into account that the weight of standard fastener 230 may also be adjusted, the adjustable levers disclosed herein have at least three separate points of weight adjustability at defined positions. The shape or profile of the adjustable lever may also be changed to provide further weight and calibration refinement. As another advantage, the multi-point weight adjustability of the levers disclosed herein provides refined tunabilty to a CVT drivetrain, including improved response and performance when shifting gears or improved functionality under different applications (e.g. a high rpm tune).

Reference will now be made in detail to exemplary embodiments of the present disclosure, wherein numerals refer to like components, examples of which are illustrated in the accompanying drawings that further show exemplary embodiments of the present disclosure, without limitation.

In an aspect, the present disclosure relates to an adjustable lever for a centrifugal actuator of a CVT drive pulley. In an embodiment, the adjustable lever comprises a first aperture operatively engageable with a head portion of an arm of the centrifugal actuator; a second aperture operatively engageable with a pivot point of the arm; a third aperture for receiving a first removable weight therewithin, the third aperture located in a first extension of the adjustable lever and positioned beyond the outer curvature of the head portion of the arm when the adjustable lever is operatively engaged with the arm; and a fourth aperture for receiving a second removable weight therewithin, the fourth aperture located in a second extension of the adjustable lever and positioned adjacent the space underneath a tail portion of the arm when the adjustable lever is operatively engaged with the arm.

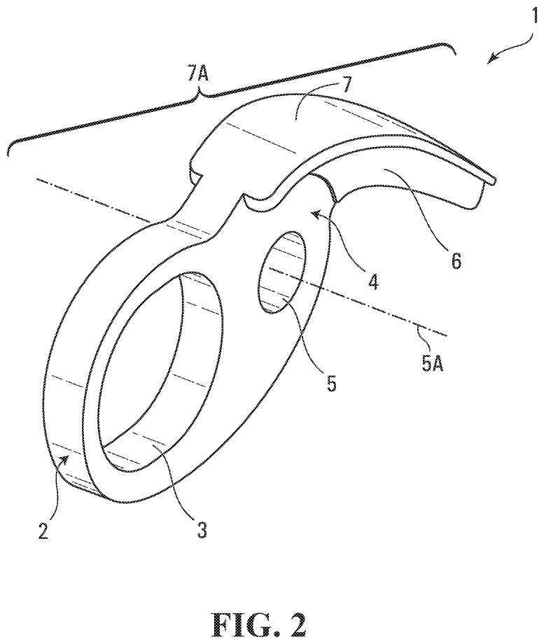

FIG. 2 is a perspective view of an exemplary prior art arm 1 of a centrifugal actuator for operatively engaging to the adjustable lever of the present disclosure. The arm 1 may comprise a head portion 2 having an aperture 3 and a tail portion 4 having an aperture 5 at a pivot point 5A.

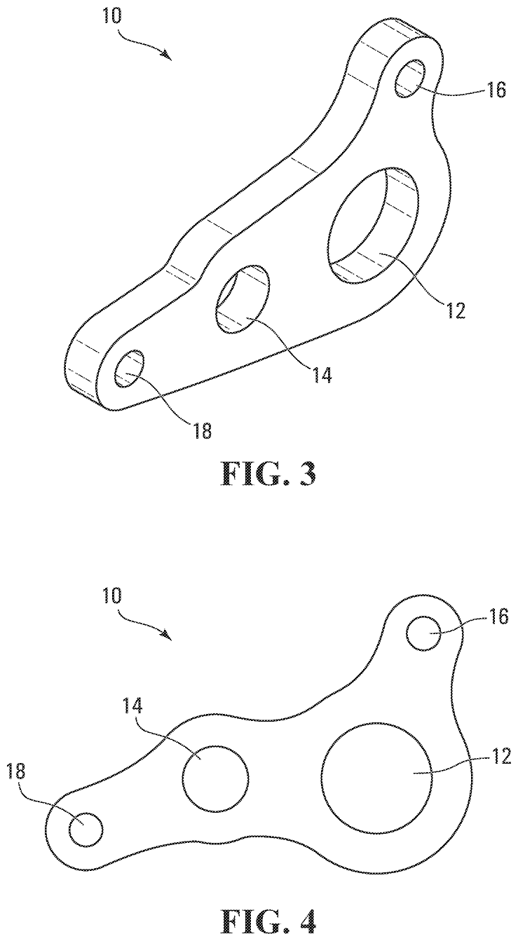

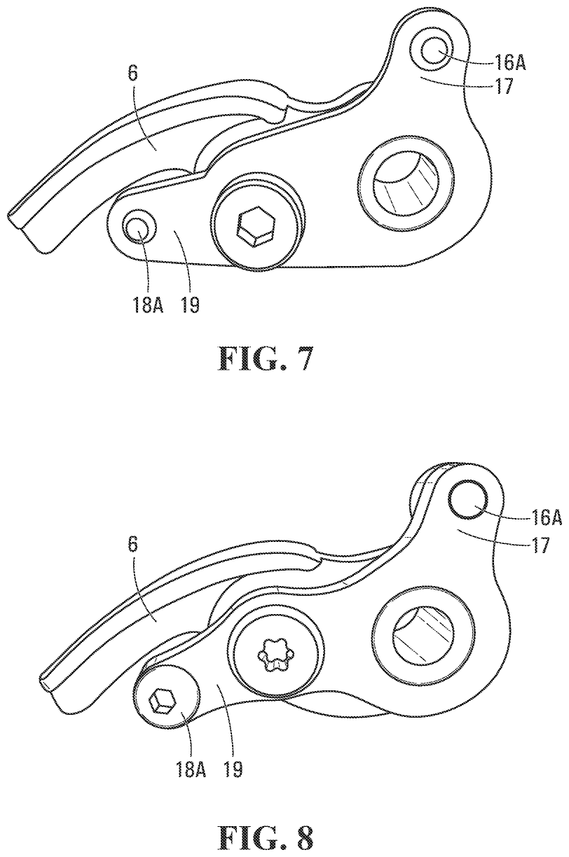

Shown in FIG. 3 and FIG. 4 are two exemplary embodiments of an adjustable lever 10 of the present disclosure. In the embodiments of FIG. 3 and FIG. 4, the adjustable lever 10 comprises a first aperture 12, a second aperture 14, a third aperture 16, and a fourth aperture 18. The third aperture 16 and fourth aperture 18 are positioned in extensions in the profile of the adjustable lever 10. As used herein, the term “extension” refers to a portion of the adjustable lever 10 that provides an additional length in a given direction as compared to a typical lever for a centrifugal actuator. The extensions are capable of positioning the third aperture 16 and fourth aperture 18 at positions to optimize calibration and to avoid the openings of the third and fourth apertures (16 and 18) from being against the side of the arm 1. The extensions position the third aperture 16 and fourth aperture 18 beyond the side of the arm 1, while maintaining an operational configuration for the centrifugal actuator (see e.g. FIG. 7 and FIG. 8). The extensions may also provide additional mass to the adjustable lever 10.

In an embodiment, one or both of the third aperture 16 and the fourth aperture 18 are threaded. In a particular embodiment, both the third aperture 16 and the fourth aperture 18 are threaded for receiving threaded removable weights (e.g. bolts). The third aperture 16 and the fourth aperture 18 may be of the same size, or not. In a particular embodiment, both the third aperture 16 and the fourth aperture 18 are of the same diameter. In some embodiments, one or both of the third aperture 16 and the fourth aperture 18 have a diameter that is smaller than that of both the first aperture 12 and the second aperture 14. While with reference to the drawings herein, the present disclosure largely discusses the third aperture 16 and the fourth aperture 18 in the context of being a circular shape, it will be appreciated that other shapes may be suitable (e.g. square, rectangle, oblong, etc.).

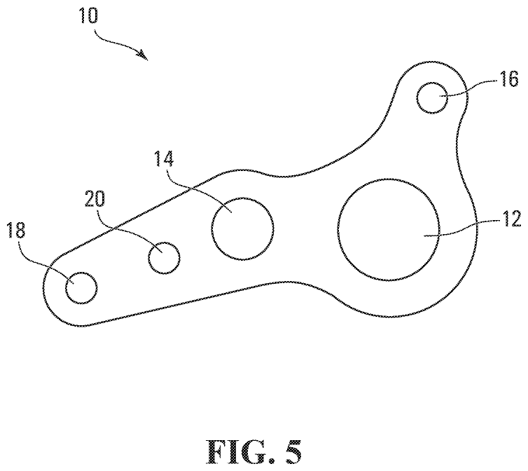

In some embodiments, the adjustable lever 10 may comprise one or more additional apertures for receiving removable weights. In some embodiments, the adjustable lever 10 may comprise a fifth aperture 20 (see, for example, FIG. 5) for receiving a removable weight. The fifth aperture 20 may be in any suitable operational position. In some embodiments, the fifth aperture 20 is located between the second aperture 14 and the fourth aperture 18.

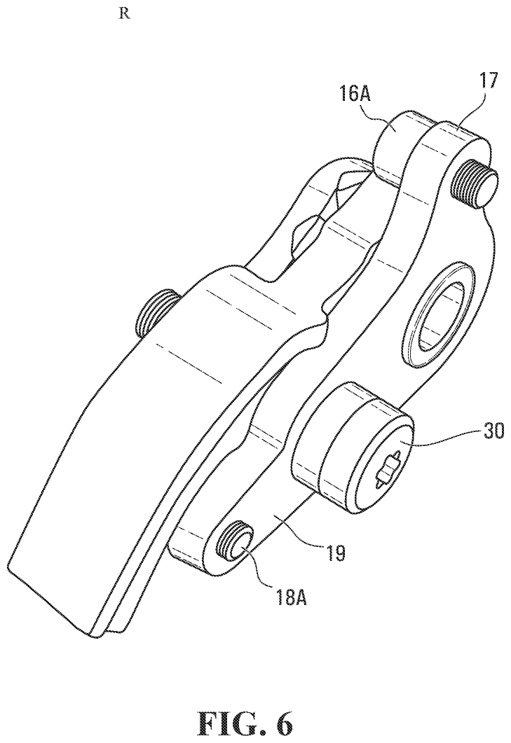

As shown in FIGS. 6-9, the adjustable lever 10 is operatively engageable with the arm 1. The first aperture 12 aligns with a corresponding aperture 3 in the head portion 2 of the arm 1. In this configuration, an axle (not shown) can pass through the first aperture 12 and the aperture 3 in the head portion 2 of the arm 1 to operatively engage the components. As will be appreciated, other components may be present to operatively engage the adjustable lever 10 at the head portion 2 of the arm 1, such as an eccentric. The first aperture 12 and the aperture 3 in the head portion 2 of the arm 1 need not be of the same size. Typically, the aperture 3 in the head portion 2 of the arm 1 is oblong and the first aperture 12 is a smaller, circular shape. The second aperture 14 aligns with a corresponding aperture 5 in the tail portion 4 of the arm 1. In this configuration, a fastener can pass through the second aperture 14 and the aperture 5 in the tail portion 4 of the arm 1 to operatively engage the components. This engagement forms a pivot point 5A about which the centrifugal actuator can pivot in operation. Typically, the second aperture 14 is of about the same size (diameter) as the corresponding aperture 5 in the tail portion 4 of the arm 1.

The tail portion 4 of the arm 1 comprises a curved arm portion 6 that defines a cam surface 7 (see FIG. 2). The cam surface 7 is capable of interacting with rollers of the drive pulley to move the movable sheave and the shaft (not shown).

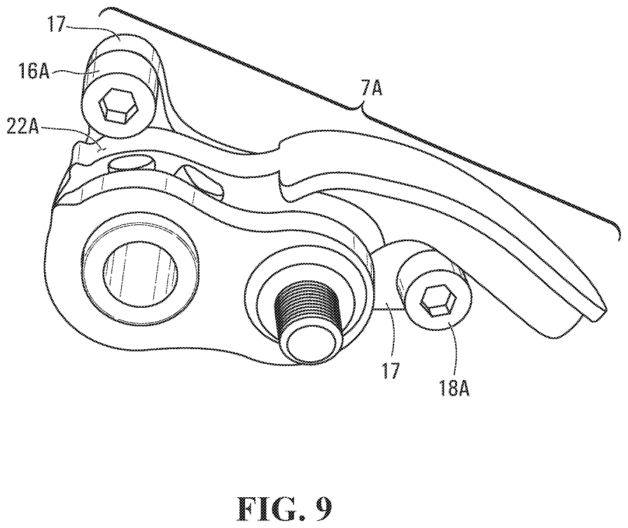

Still with reference now to FIGS. 6-9, the third aperture 16 is for receiving a first removable weight 16A and is located in a first extension 17 of the adjustable lever 10 and positioned beyond the outer curvature 2A of the head portion 2 when the adjustable lever 10 is operatively engaged with the arm 1. As used herein, the expression “beyond the outer curvature of the head portion” is intended to refer to the third aperture 16 being located at a distance from the surface of the outer curvature 2A of the head portion 2. By this, it is meant that the third aperture is not against the side of the arm, but rather positioned beyond the profile of the arm 1. In some embodiments, the first extension 17 is positioned beyond the outer curvature 2A of the head portion 2 and on a cam surface side 7A of the arm 2 (as shown in FIG. 9). As used herein, the term “cam surface side” is intended to refer to the entire side of the arm 1 on which the cam surface 7 resides. In some embodiments, at least a portion of the first removable weight 16A may abut the surface of the outer curvature 22A when received in the third aperture 16.

The fourth aperture 18 is for receiving a second removable weight 18A and is located in a second extension 19 of the adjustable lever 10. When the adjustable lever 10 is operatively engaged with the arm 1, the second removable weight 18A is positioned adjacent the space underneath the tail portion 4 of the arm 1. As used herein, the expression “space underneath the tail portion” is intended to refer to the space between the pivot point 5A and the end of the tail portion 4 distal the pivot point 5A and bordered by the underside of the curved arm portion 6. In some embodiments, at least a portion of the second removable weight 18A extends into the space underneath the tail portion 4 when the second removable weight 18A is received in the fourth aperture 18 and when the adjustable lever 10 is operatively engaged with the arm 1.

As above, the adjustable lever 10 may comprise one or more additional apertures. In an embodiment, the adjustable lever 10 comprises a fifth aperture 20 for receiving a third removable weight (not shown). In some embodiments, the fifth aperture 20 is located between the second aperture 14 and the fourth aperture 18 and positioned adjacent the space underneath the tail portion 4 of the arm 1 when the adjustable lever 10 is operatively engaged with the arm 1. In some embodiments, at least a portion of the third removable weight extends under the tail portion 4 of the arm 1 when the third removable weight is received in the fifth aperture 20 and when the adjustable lever 10 is operatively engaged with the arm 1.

The first removable weight 16A and the second removable weight 18A may advantageously provide two points of weight adjustability to the adjustable lever 10. While the embodiments illustrated in the present disclosure show the first removable weight 16A and the second removable weight 18A as being bolts, it will be appreciated that other removable weights may be used. In some embodiments, the first removable weight 16A and the second removable weight 18A may be bolts, screws, nuts, washers, binding posts, barrel nuts, magnets, or any combination thereof. Non-limiting examples of bolts include carriage bolts, barrel bolts, arbor bolts, shoulder bolts, square bolts, round bolts, hex bolts, sex bolts, and flanged bolts. Non-limiting examples of screws include machine screws, socket screws, and mating screws.

In some embodiments, each of the first removable weight 16A and the second the second removable weight 18A include a bolt or a screw. The bolts and screws may be threaded, or not. In some embodiments, each of the first removable weight 16A and the second the second removable weight 18A includes a bolt or screw and a nut. In some embodiments, each of the first removable weight 16A and the second the second removable weight 18A include a bolt or screw and a washer. The washers may be used to make fine adjustments to the mass of the first removable weight 16A and/or the second removable weight 18A. Any number of nuts and/or washers may be used together with a bolt or screw as the first removable weight 16A or the second the second removable weight 18A.

In some embodiments, the first removable weight 16A and the second removable weight 18A are of the same type (e.g. both are bolts). In some embodiments, the first removable weight 16A and the second removable weight 18A are of a different type (e.g. one is a screw and one is a bolt and nut). The configuration can be adjusted, having regard to the present disclosure, to provide proper adjustability for performance, response and calibration.

The first removable weight 16A and the second removable weight 18A may be of any suitable material and may be of the same material, or not. In some embodiments, the first removable weight 16A and the second removable weight 18A are comprised of a metal, a metallic alloy, a metalloid, or any combination thereof. In some embodiments, the first removable weight 16A and the second removable weight 18A are individually selected from steel, stainless steel, carbon steel, alloy steel, iron, aluminum, magnesium, copper, brass, nickel, tin, cobalt, lead, bronze, platinum, tungsten, or titanium. In the case of metalloids, exemplary embodiments include silicon bronze (e.g. silicon bronze bolts). In some embodiments, the first removable weight 16A and the second removable weight 18A may be comprised of a non-metallic material, such as a polymeric material, such as a polyurethane. In a particular embodiment, the first removable weight 16A and the second removable weight 18A are made of stainless steel.

In some embodiments, the first removable weight 16A and the second removable weight 18A each have an individual mass of between about 0.05 g and about 50 g, more particularly between about 0.1 g and about 20 g. In an embodiment, the first removable weight 16A and the second removable weight 18A each have an individual mass of about 0.1 g, about 0.5 g, about 0.75 g, about 1 g, about 1.5 g, about 2 g, about 2.5 g, about 3 g, about 3.5 g, about 4 g, about 4.5 g, about 5 g, about 5.5 g, about 6 g, about 6.5 g, about 7 g, about 7.5 g, about 8 g, about 8.5 g, about 9 g, about 9.5 g, about 10 g, about 10.5 g, about 11 g, about 11.5 g, about 12 g, about 12.5 g, about 13 g, about 13.5 g, about 14 g, about 14.5 g, about 15 g, about 15.5 g, about 16 g, about 16.5 g, about 17 g, about 17.5 g, about 18 g, about 18.5 g, about 19 g, about 19.5 g, or about 20 g.

As above, the adjustable lever 10 may comprise one or more additional apertures for receiving removable weights. The removable weights for the one or more additional apertures may any of the weights, materials, and sizes as described elsewhere herein for the first and/or second removable weight 16A/18A. In a particular embodiment, the adjustable lever 10 comprises a fifth aperture 20 for receiving a third removable weight. In an embodiment, the third removable weight comprises bolts.

In some embodiments of the present disclosure, the adjustable lever 10 has a weight of between about 5 g and about 100 g without the first removable weight 16A or the second removable weight 18A, more particularly between about 7 g and about 50 g. In an embodiment, the adjustable lever 10 has a mass of about 5 g, about 6 g, about 7 g, about 8 g, about 9 g, about 10 g, about 15 g, about 20 g, about 25 g, about 30 g, about 35 g, about 40 g, about 45 g, or about 50 g without the first removable weight 16A or the second removable weight 18A. In a particular embodiment, the adjustable lever 10 has a mass of about 50 g without the first removable weight 16A or the second removable weight 18A. In another particular embodiment, the adjustable lever has a mass of about 7 g without the first removable weight 16A or the second removable weight 18A.

In some embodiments, when the first removable weight 16A is received in the third aperture 16 and the second removable weight 18A is received in the fourth aperture 18, the adjustable lever 10 has an adjustable mass of between about 6 g and about 120 g, more particularly between about 8 g and about 80 g. In an embodiment, the adjustable mass of the adjustable lever 10 is about 8 g, about 9 g, about 10 g, about 15 g, about 20 g, about 25 g, about 30 g, about 35 g, about 40 g, about 45 g, about 50 g, about 55 g, about 60 g, about 65 g, about 70 g, about 75 g, or about 80 g. Without being bound by any particular theory, the ability to adjust the mass of lever 10 may provide for improved performance, response or calibration, for example when shifting gears of the CVT. By “adjustable mass”, it is meant that the mass of the adjustable lever 10 may be altered by replacement of the first removable weight 16A and/or second removable weight 18A with weights having a different mass, to thereby adjust the mass of the adjustable lever 10.

The adjustable lever 10 may be comprised of any suitable material to achieve a target mass. In some embodiments, the adjustable lever 10 is comprised of a metal, a metal alloy, a metalloid, or any combination thereof. Without limitation, the material may be any of those described herein in respect of the adjustable weights. In some embodiments, the adjustable lever 10 is comprised of steel, stainless steel, aluminum, or titanium. In a particular embodiment, the adjustable lever 10 is comprised of stainless steel. In another particular embodiment, the adjustable lever 10 is comprised of aluminum. In yet another particular embodiment, the adjustable lever 10 is comprised of titanium. In other embodiments, the adjustable lever 10 may be comprised of a non-metallic material, such as a polymeric material, such as a polyurethane.

The adjustable lever 10 may be of any suitable shape for operatively coupling to the arm 1 and for accommodating the first extension 17 and the second extension 19 without interfering with the operation of the arm 1 or any other components of the centrifugal actuator and the CVT. It will be appreciated that the shape of the adjustable lever 10 may vary between applications, for example between use in a snowmobile and use in a side-by-side vehicle.

Shown in FIGS. 7-8 are exemplary shapes for the adjustable lever 10. As can be seen, the embodiment of FIG. 7 has a different shape than the embodiment of FIG. 8. Nevertheless, in both embodiments, the first adjustable weight 16A is positioned beyond the outer curvature 22A of the head portion 2 (see FIG. 9 also). More particularly, in these embodiments, the first adjustable weight 16A is on a cam surface side 7A of the arm 22. This position for the first adjustable weight 16A relative to the arm 1 was found to be ideal for operation and improvement of performance, response and calibration. However, the skilled person will appreciate that the position may be altered within the confines of the present disclosure for any particular application, functionality or tuning purpose. Moreover, the size and the mass of the first adjustable weight 16A may be adjusted as described herein.

Likewise, as can be seen in FIG. 7 and FIG. 8, although these embodiments of adjustable levers 10 have different shapes, the second adjustable weight 18A in both is positioned underneath the tail portion 4 of the arm 1 (see FIG. 9 also). More particularly, in these embodiments, the second adjustable weight 18A is between the pivot point 5A and the end of the tail portion 4 distal the pivot point 5A. Comparing the two embodiments, it can be seen that the embodiment of FIG. 8 positions the second adjustable weight 18A slightly further away from the underside of the curved arm portion 6. Slight adjustments to the position of the fourth aperture 18, while maintaining the second adjustable weight 18A at a position that is adjacent and/or underneath the tail portion 4 or the arm 1 was found to be ideal for operation and improvement of performance, response and calibration. Slight differences in position can be used for tuning and calibration for desired operator experience. Again, the skilled person will appreciate that the position of the second adjustable weight 18A may be altered within the confines of the present disclosure for any particular application, functionality or tuning purpose. Moreover, the size and the mass of the second adjustable weight 18A may be adjusted as described herein.

The skilled person will recognize, based on the present disclosure, that alternate means may be used to secure the first removable weight 16A and/or the second removable weight 18A to the adjustable lever 10 of the present disclosure.

Thus, in some embodiments, the present disclosure relates to an adjustable lever for a centrifugal actuator of a continuously variable transmission drive pulley, the adjustable lever comprising: a first aperture operatively engageable with a head portion of an arm of the centrifugal actuator; a second aperture operatively engageable with a pivot point of the arm; a first receiver for receiving a first removable weight therewithin, the first receiver located on a first extension of the adjustable lever and positioned beyond the outer curvature of the head portion of the arm when the adjustable lever is operatively engaged with the arm; and a second receiver for receiving a second removable weight therewithin, the second receiver located on a second extension of the adjustable lever and positioned adjacent the space underneath a tail portion of the arm when the adjustable lever is operatively engaged with the arm.

As used herein, the terms “first receiver” and “second receiver” are intended to refer to any structure that is capable of receiving and/or securing the first removable weight and the second removable weight, respectively. The first receiver and the second receiver may be of the same size and/or type, or not. Non-limiting examples of a receiver may include a pocket, a sleeve, a recess, a depression, a hollow, a cavity, an aperture, or a socket. Indeed, the foregoing embodiments relating to the adjustable lever 10 having third and fourth apertures (16 and 18) are non-limiting examples adjustable levers of the present disclosure having first and second receivers.

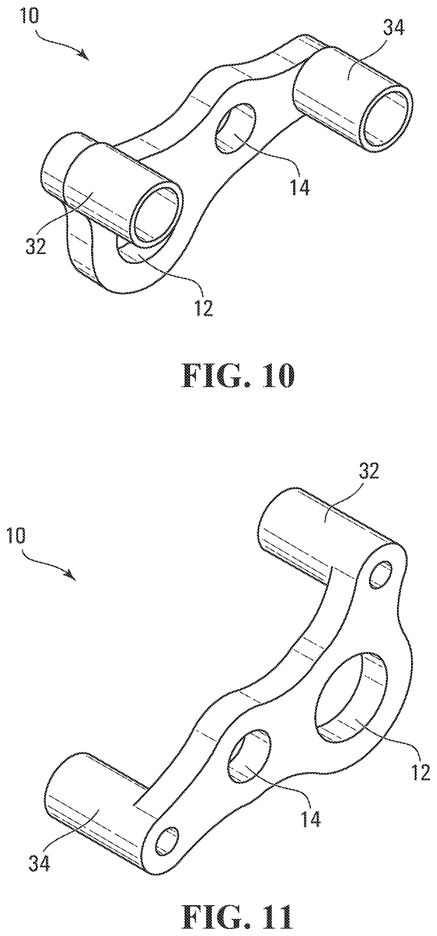

FIG. 10 and FIG. 11 show two non-limiting examples of an adjustable lever 10 comprising the first receiver 32 and the second receiver 34, according to some embodiments of the present disclosure.

In some embodiments, the first receiver 32 and the second receiver 34 may comprise cylindrical structures for receiving one or more removable weights. In some embodiments, the first receiver 32 and the second receiver 34 may be operatively coupled to the adjustable lever 10 by a suitable means, such as for example, by screws. In a particular embodiment, the first receiver 32 and the second receiver 34 are cylinders of different sizes that are removeably coupleable to the adjustable lever 10, thereby adding further weight adjustability to the adjustable lever 10. In some embodiments, the first receiver 32 and the second receiver 34 may be fused to the adjustable lever 10. In some embodiments, the adjustable lever 10 and the first receiver 32 and the second receiver 34 are formed from a single piece of material and are a monolithic structure. In a particular embodiment, the first removable weight and the second removable weight are magnets.

In some embodiments, the adjustable lever 10 may comprise one or more additional receivers, such as a third receiver. The third receiver may be located at a suitable operational location and may be any of the receivers described for the first and/or second receivers 32/34 elsewhere herein.

It will be appreciated that any removable weight discussed earlier herein may be used depending on the structure of the first receiver and the second receiver. It will also be appreciated that additional and different removable weights may be used depending on the configuration of the first and second receivers. For example, the first and/or second removable weight may be a shaped piece of metal or other material held in position by the first and second receivers, but which removable weight does not pass through the adjustable lever. Rather, in an embodiment, the removable weight may be positioned on one side of the adjustable lever, held in place by the first or second receiver, respectively.

It will further be appreciated that any configuration, shape and/or profile of the adjustable lever 10 described herein is equally applicable to an adjustable lever having first and second receivers.

In another aspect, the present disclosure also provides kits comprising the adjustable levers disclosed herein, and at least one of the first removable weight, at least one of the second removable weight, or both.

In an embodiment, the present disclosure relates to a kit comprising: an adjustable lever for a centrifugal actuator of a continuously variable transmission drive pulley, the adjustable lever comprising: a first aperture operatively engageable with a head portion of an arm of the centrifugal actuator; a second aperture operatively engageable with a pivot point of the arm; a third aperture for receiving a first removable weight therewithin, the third aperture located in a first extension of the adjustable lever and positioned beyond the outer curvature of the head portion of the arm when the adjustable lever is operatively engaged with the arm; and a fourth aperture for receiving a second removable weight therewithin, the fourth aperture located in a second extension of the adjustable lever and positioned adjacent the space underneath a tail portion of the arm when the adjustable lever is operatively engaged with the arm, and at least one of the first removable weight, the second removable weight, or both.

In some embodiments, the kit comprises at least one of the first removable weight 16A and at least one of the second removable weight 18A. In an embodiment, the kit comprises a plurality of the first removable weight 16A and a plurality of the second removable weight 18A. In an embodiment, the first removable weights 16A in the kit are different than the second removable weights 18A, such that the weights are not interchangeable. In other embodiments, the removable weights included within the kit are interchangeable as between use as the first removable weight 16A or the second removable weight 18A. Thus, in some embodiments, the kits disclosed herein provide a plurality of removable weights having different masses that may be used as one or both of the first removable weight 16A and the second removable weight 18A.

As described, the kits may comprise a plurality of removable weights. In an embodiment, the kits comprise removable weights of different masses which may be used as either the first removable weight 16A and/or the second removable weight 18A. So that weights of the same mass may be used both as the first removable weight 16A and the second removable weight 18A, in an embodiment the kits comprise at least two weights of each given mass for each adjustable lever in the kit (e.g. a kit having three levers would comprise six removable weights of the same mass).

In other embodiments, the kits comprise a plurality of distinct first removable weights 16A and a plurality of distinct second removable weights 18A, whereby the first and second removable weights are not interchangeable. In an embodiment, each of the plurality of the first removable weights 16A is of a different weight and each of the plurality of the second removable weights 18A is of a different weight.

The removable weights within the kits may be any of the removable weights described elsewhere herein. In some embodiments, the first removable weight 16A and the second removable weight 18A comprise bolts or screws. In some embodiments, the first removable weight 16A and the second removable weight 18A comprise bolts and washers or screws and washers. In some embodiments, the first removable weight 16A and the second removable weight 18A each have an individual mass between about 0.1 g and about 20 g. The mass may be provided by a single component (e.g. bolt, screw, etc.) or a combination of components (e.g. bolt and one or more washers).

In some embodiments, the kits disclosed herein comprise the adjustable lever 10 having the third and fourth apertures (16 and 18). The adjustable lever 10 may be any adjustable lever comprising the third aperture 16 and the fourth aperture 18 described herein. In some embodiments of the kits disclosed herein, one or both of the third aperture 16 and the fourth aperture 18 are threaded. In some embodiments, one or both of the third aperture 16 and the fourth aperture 18 have a diameter that is smaller than both the first aperture 12 and the second aperture 14. In some embodiments, the kits disclosed herein comprise the adjustable lever 10 having a fifth aperture (20). In some embodiments, the fifth aperture 20 is for receiving a third removable weight. In some embodiments, the kits disclosed herein further comprise the third removable weight. The third removable weight may be as described elsewhere herein in respect of removable weights. In a particular embodiment, the third removable weight comprises bolts.

In some embodiments, the kits disclosed herein comprise the adjustable lever disclosed herein having first and second receivers. Thus, in an embodiment, the present disclosure relates to a kit comprising: an adjustable lever for a centrifugal actuator of a continuously variable transmission drive pulley, the adjustable lever comprising: a first aperture operatively engageable with a head portion of an arm of the centrifugal actuator; a second aperture operatively engageable with a pivot point of the arm; a first receiver for receiving a first removable weight therewithin, the first receiver located on a first extension of the adjustable lever and positioned beyond the outer curvature of the head portion of the arm when the adjustable lever is operatively engaged with the arm; and a second receiver for receiving a second removable weight therewithin, the second receiver located on a second extension of the adjustable lever and positioned adjacent the space underneath a tail portion of the arm when the adjustable lever is operatively engaged with the arm, and at least one of the first removable weight, the second removable weight, or both.

Irrespective of the type of adjustable lever, the kits of the present disclosure may comprise any number of the adjustable levers. In an embodiment, the kits disclosed herein comprise 1, 2, 3, 4, 5, 6, 7, 8, 9, or more of the adjustable levers. In a particular embodiment, each kit comprises three adjustable levers. In an embodiment, each of the adjustable levers in the kits is the adjustable lever 10 as disclosed herein. In an embodiment, each of the three adjustable levers in the kits are the same (e.g. three adjustable levers as shown in FIG. 7 or three adjustable levers as shown in FIG. 8).

In an embodiment, the adjustable lever(s) in the kits of the present disclosure are comprised of stainless steel, aluminum, or titanium. In a particular embodiment, the adjustable lever(s) are is comprised of stainless steel. In another particular embodiment, the adjustable lever(s) are comprised of aluminum. In yet another particular embodiment, the adjustable lever(s) are comprised of titanium.

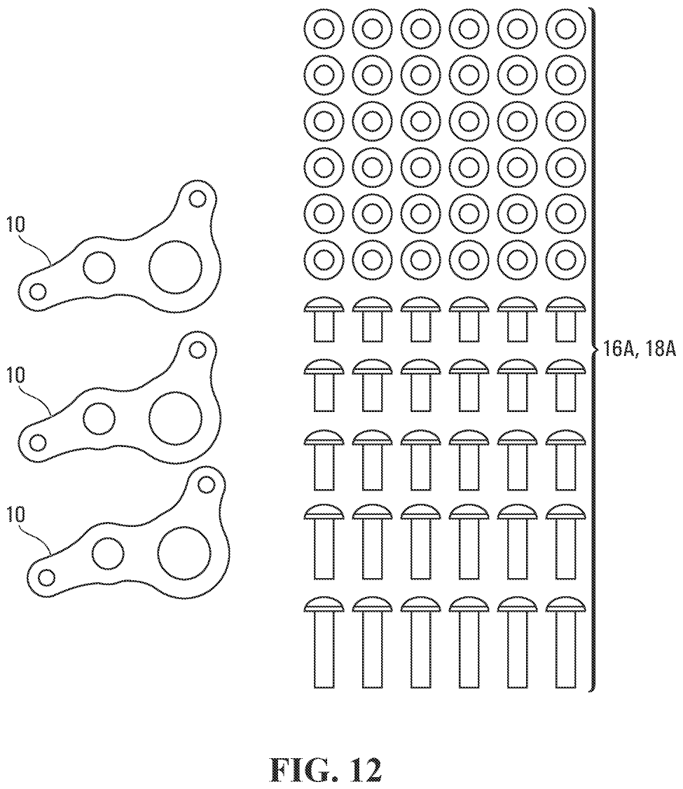

An exemplary embodiment of a kit of the present disclosure is illustrated in FIG. 12, which shows a kit comprising three of the adjustable levers 10, six bolts of each of five different weights (thirty total), and forty-two washers. As described elsewhere herein, the washers maybe used together with the bolts to provide a desired weight for each of the first and second removable weights.

In some embodiments, the kits of the present disclosure may comprise at least one pivot weight 30, such as for example shown in FIG. 6. As used herein, the term “pivot weight” refers to a weight that may be positionable at the pivot point 5A of the arm 1 and secured between the second aperture 14 of the adjustable lever 10 and the arm 1 of the centrifugal actuator. The inclusion of the pivot weight in the kits herein allow for a third point of mass adjustability of the centrifugal actuator. In this regard, the kits herein may comprise a number of pivot weights having different masses, and typically would include one pivot weight of each mass for each adjustable lever within the kit.

In some embodiments, the kit further comprises instructions. In an embodiment, the instructions may provide guidance on selections for the first removable weight 16A, the second movable weight 18A, the pivot weight, or combinations thereof to assist the operator in achieving a target performance level of the CVT drive pulley. The instructions may, for example, provide guidance on the mass and/or the removable weight components (e.g. bolts, washers, etc.) to be used for each of the first removable weight 16A and the second movable weight 18A to obtain a desired performance, response, or calibration for a particular application or functionality (e.g. a high elevation ride, a high rpm tune, etc.).

Unless otherwise defined, all technical and scientific terms used herein generally have the same meaning as commonly understood by one of ordinary skill in the art to which this disclosure pertains.

Many obvious variations of the embodiments set out herein will suggest themselves to those skilled in the art in light of the present disclosure. Such obvious variations are within the scope of the appended claims.

As used herein, the term “about”, when referring to a measurable value such as a weight, a dimension, and the like, is meant to encompass variations of ±10%, ±5%, ±1%, ±0.5% or ±0.1% of the specified amount. When the value is a whole number, the term about is meant to encompass decimal values, as well the degree of variation just described. It is to be understood that such a variation is always included in any given value provided herein, whether or not it is specifically referred to.

“And/or” refers to and encompasses any and all possible combinations of one or more of the associated listed items (e.g. one or the other, or both), as well as the lack of combinations when interrupted in the alternative (or).

“Comprise” as is used in this description and in the claims, and its conjugations, is used in its non-limiting sense to mean that items following the word are included, but items not specifically mentioned are not excluded.

1. An adjustable lever for a centrifugal actuator of a continuously variable transmission drive pulley, the adjustable lever comprising:
a first aperture operatively engageable with a head portion of an arm of the centrifugal actuator;
a second aperture operatively engageable with a pivot point of the arm;
a third aperture for receiving a first removable weight therewithin, the third aperture located in a first extension of the adjustable lever and positioned beyond the outer curvature of the head portion of the arm when the adjustable lever is operatively engaged with the arm; and
a fourth aperture for receiving a second removable weight therewithin, the fourth aperture located in a second extension of the adjustable lever and positioned adjacent the space underneath a tail portion of the arm when the adjustable lever is operatively engaged with the arm.

2. The adjustable lever of claim 1, wherein the third aperture is positioned on a cam surface side of the arm when the adjustable lever is operatively engaged with the arm.

3. The adjustable lever of claim 1, wherein at least a portion of the second removable weight extends under the tail portion of the arm when the second removable weight is received in the fourth aperture and when the adjustable lever is operatively engaged with the arm.

4. The adjustable lever of claim 1, wherein one or both of the third aperture and the fourth aperture are threaded.

5. The adjustable lever of claim 4, wherein one or both of the first removable weight and the second removable weight comprise bolts.

6. The adjustable lever of claim 1, wherein:
the adjustable lever has a weight of between about 7 g and about 50 g without the first removable weight or the second removable weight; and
when the first removable weight is received in the third aperture and the second removable weight is received in the fourth aperture, the adjustable lever has an adjustable mass of between about 8 g and about 80 g.

7. The adjustable lever of claim 1, wherein the lever is comprised of stainless steel, aluminum or titanium.

8. The adjustable lever of claim 1, wherein:
the third aperture and the fourth aperture have a diameter that is smaller than that of both the first aperture and the second aperture; and
the third aperture and the fourth aperture are the same size.

9. The adjustable lever of claim 1, further comprising a fifth aperture for receiving a third removable weight therewithin.

10. An adjustable lever for a centrifugal actuator of a continuously variable transmission drive pulley, the adjustable lever comprising:
a first aperture operatively engageable with a head portion of an arm of the centrifugal actuator;
a second aperture operatively engageable with a pivot point of the arm;
a first receiver for receiving a first removable weight therewithin, the first receiver located on a first extension of the adjustable lever and positioned beyond the outer curvature of the head portion of the arm when the adjustable lever is operatively engaged with the arm; and
a second receiver for receiving a second removable weight therewithin, the second receiver located on a second extension of the adjustable lever and positioned adjacent the space underneath a tail portion of the arm when the adjustable lever is operatively engaged with the arm.

11. The adjustable lever of claim 10, wherein the first receiver and the second receiver comprise cylinder structures for receiving the first and second removable weights.

12. The adjustable lever of claim 11, wherein the first removable weight and the second removable weight comprise magnets.

13. The adjustable lever of claim 10, wherein the first receiver is positioned on a cam surface side of the arm when the adjustable lever is operatively engaged with the arm.

14. The adjustable lever of claim 13, wherein at least a portion of the second receiver extends under the tail portion of the arm when the adjustable lever is operatively engaged with the arm.

15. A kit comprising:
an adjustable lever for a centrifugal actuator of a continuously variable transmission drive pulley, the adjustable lever comprising:
a first aperture operatively engageable with a head portion of an arm of the centrifugal actuator;
a second aperture operatively engageable with a pivot point of the arm;
a first receiver for receiving a first removable weight therewithin, the first receiver located in a first extension of the adjustable lever and positioned beyond the outer curvature of the head portion of the arm when the adjustable lever is operatively engaged with the arm; and
a second receiver for receiving a second removable weight therewithin, the second receiver located in a second extension of the adjustable lever and positioned adjacent the space underneath a tail portion of the arm when the adjustable lever is operatively engaged with the arm, and
at least one of the first removable weight, the second removable weight, or both.

16. The kit of claim 15, comprising a plurality of the first removable weights and a plurality of the second removable weights, wherein each of the first removable weights is of a different weight and each of the second removable weights is of a different weight.

17. The kit of claim 15, wherein the first receiver is a third aperture and the second receiver is a fourth aperture.

18. The kit of claim 17, wherein the third aperture and the fourth aperture are threaded and the first removable weight and the second removable weight comprise bolts.

19. The kit of claim 15, wherein the adjustable lever further comprises a fifth aperture for receiving a third removable weight therewithin, and the kit further comprises the third removable weight.

20. The kit of claim 15, wherein the first receiver and the second receiver comprise cylinder structures for receiving the first and second removable weights, and the kit further comprises the cylinder structures.

21. The kit of claim 17, wherein the first removable weight and the second removable weight comprise magnets.

22. The kit of claim 15, further comprising at least one pivot weight.
